(19) United States
(12) Patent Application Publication
(10) Pub. No.: US 2007/0016709 A1
(43) Pub. Date: Jan. 18, 2007

(54) Bus control system and a method thereof

(75) Inventor: Atsushi Kazama, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/476,698

(22) Filed: Jun. 29, 2006

(30) Foreign Application Priority Data
Jul. 15, 2005 (JP) 2005-206377

(51) Int. Cl. G06F 13/36

(52) U.S. Cl. 710/113

(57) ABSTRACT

A bus control system includes a plurality of bus masters commonly connected to a bus, a bus arbiter for arbitrating use of the bus between the plurality of bus masters according to any one of a plurality of predetermined arbitration algorithms, and an arbitration algorithm control unit for switching the plurality of arbitration algorithms.

### BACKGROUND OF THE INVENTION

1. Field of the Invention

The present invention relates to a bus control system and a method thereof, and particularly to a bus control system comprising a bus arbiter for arbitrating use of a bus between a plurality of bus masters and a method thereof.

2. Description of Related Art

A bus control system for connecting a plurality of devices to one bus and for arbitrating use of the bus between the devices is conventionally used. A device requesting for a use of the bus is referred to as a bus master. A device being accessed by the bus master through the bus is referred to as a bus slave. An arbitration circuit for granting (arbitrating) use of the bus to a bus master is referred to as an arbiter.

In recent years, systems become more complicated as an information processing unit and an electronic equipment etc develop to be more efficient and to have more sophisticated functions, leading to increase bus masters connected to a bus. Data transferred and processed by a bus is also diversified, including information that tolerates transfer delay (for example text information), and information that does not tolerate transfer delay (for example audio and movie information). Therefore, a technique for more efficiently arbitrating use of a bus is desired.

In a bus control system, an arbiter performs an arbitration by granting to use a bus in order defined by a specified arbitration algorithm and providing a right to use the bus. There are two methods for arbitration algorithm, which are; a fixed priority method where a bus master with a higher priority is preferentially given a right to use a bus, and a round robin method where each bus master is given a right to use a bus at the same rate. A conventional arbiter arbitrates for a bus using either the fixed priority method or the round robin method.

A conventional arbiter using the fixed priority method is disclosed in Japanese Unexamined Patent Publication Application No. 6-243092, for example. FIG. 14 shows a configuration of a conventional bus control system disclosed in Japanese Unexamined Patent Publication Application No. 6-243092. Bus masters 901a, 901b, and a bus slave 910 are commonly connected to a bus 940. An arbiter 920 arbitrates use of the bus 940 in response to requests for using the bus from the bus masters 901a and 901b. If granted to use the bus, the bus masters 901a and 901b transfer data to the bus slave 910 via the bus 940.

A bus monitor circuit 950 monitors the data transfer performed in the bus 940, and specifies priorities of the bus masters 901a and 901b to a priority register 930 based on a communication frequency detected and a waiting time for the bus. The arbiter 920 grants either the bus master 901a or the bus master 901b to use the bus according to the priority stored in the priority register 930. An error such as overrun and underrun is reduced by prioritizing a bus master with longer bus waiting time, for instance.

However in a conventional bus control system, an arbiter performs a bus arbitration always with only the fixed priority method. In a case the round robin method is applied instead of the fixed priority method, a bus arbitration is performed only with the round robin method. Specifically, the conventional bus control system operates with only one arbitration algorithm, either the fixed priority method or the round robin method, defined in advance by an arbiter. The conventional bus control system changes an order of arbitration within a range of one arbitration algorithm. That is, the conventional bus control system performs an arbitration according to the same factor (element) which is a priority, even after changing the priority.

In the conventional bus control system, if the fixed priority method is used for transferring data that is suitable for the fixed priority method, a bus can be efficiently arbitrated and utilized. However if the fixed priority method is used for transferring data that is suitable for the round robin method, the bus cannot be efficiently arbitrated and utilized. Similarly in the conventional bus control system, if the round robin method is used for transferring data that suitable for the fixed priority method, the bus cannot be efficiently utilized. If bus cannot be used efficiently, waiting time for data transfer may increase, an overrun or an underrun may be generated, may cause a bottleneck for a data transfer, thereby lowering system performance. The conventional bus control system is therefore not able to arbitrate for a bus with a most appropriate arbitration algorithm at any time.

Furthermore in the conventional bus control system, a bus monitor circuit is required for monitoring communication frequency and data transfer waiting so as to switch the priorities and a switch timing is determined by hardware. For this reason, the priorities are switched only when predetermined conditions are detected. By specifying a threshold of a bus waiting time to change the priorities depending on the bus waiting time, a minimum throughput for a bus master can be guaranteed. However it requires to detect even the threshold of the bus waiting time and does not always select the most appropriate priorities. Furthermore with hardware control, a circuit for detecting a waiting time etc is required for each bus or bus master. If the number of buses or bus masters is large, the circuit can be complicated, increasing a circuit size.

As described in the foregoing, it has now been discovered that the conventional bus control system is not always able to arbitrate for a bus with a most appropriate arbitration algorithm, and to efficiently use the bus because only a specified arbitration algorithm can be used to arbitrate for the bus.

### SUMMARY OF THE INVENTION

According an aspect of the present invention, there is provided a bus control system that includes a plurality of bus masters commonly connected to a bus, a bus arbiter for arbitrating use of the bus between the plurality of bus masters according to any one of a plurality of arbitration algorithms, and an arbitration algorithm control unit for switching the plurality of arbitration algorithms. The bus control system enables to switch the arbitration algorithm of the bus arbiter and to arbitrate use of the bus with a most appropriate arbitration algorithm, thereby allowing to efficiently use the bus.

According to another aspect of the present invention, there is provided a bus control system that includes a plurality of bus masters commonly connected to a bus, a bus arbiter for arbitrating use of the bus between the plurality of bus masters according to a predetermined arbitration algorithm, and an arbitration algorithm control unit for switching priorities or an arbitration order of the plurality of the bus masters. The bus control system enables to switch the priorities or the arbitration order within one arbitration algorithm such as round robin method or fixed priority method, allowing to arbitrate use of the bus with a most appropriate arbitration algorithm and to efficiently use the bus.

According to another aspect of the present invention, there is provided a bus control method for arbitrating use of a bus between a plurality of bus masters that includes arbitrating use of the bus between the plurality of the bus masters according to any one of a plurality of different arbitration algorithms being determined in advance, and switching the plurality of arbitration algorithms based on processes to be executed by the plurality of the bus masters. The bus control method enables to switch the arbitration algorithms for the bus, allowing to arbitrate use of the bus with a most appropriate arbitration algorithm and to efficiently use the bus.

The present invention provides a bus control system and a method that allows to efficiently use a bus by selecting a bus master to arbitrate for the bus.

### BRIEF DESCRIPTION OF THE DRAWINGS

The above and other objects, advantages and features of the present invention will be more apparent from the following description taken in conjunction with the accompanying drawings, in which:

FIG. 1 is a configuration diagram showing a configuration of a bus control system according to the present invention;

FIGS. 2A and 2B are explanatory diagrams for explaining an arbitration algorithm according to the present invention;

FIGS. 3A and 3B are explanatory diagrams for explaining an arbitration algorithm according to the present invention;

FIG. 4 is a block diagram showing a configuration of a system control unit according to the present invention;

FIG. 5 is a flow chart showing a bus control process according to the present invention;

FIG. 6 is a flow chart showing an arbitration algorithm determination process according to the present invention;

FIGS. 7A and 7B are explanatory diagrams for explaining arbitration algorithms according to the present invention;

FIG. 8 is a configuration diagram showing a configuration of a bus control system according to the present invention;

FIGS. 9A and 9B are explanatory diagrams for explaining arbitration algorithms according to the present invention;

FIGS. 10A and 10B are explanatory diagrams for explaining arbitration algorithms according to the present invention;

FIGS. 11A and 11B are explanatory diagrams for explaining arbitration algorithms according to the present invention;

FIGS. 12A and 12B are explanatory diagrams for explaining arbitration algorithms according to the present invention;

FIG. 13 is a flow chart showing an arbitration algorithm determination process according to the present invention; and

FIG. 14 is a configuration diagram showing a configuration of a bus control system according to a conventional control system.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

A bus control system of a first embodiment is described in detail hereinafter. The bus control system of this embodiment is characterized in that it switches arbitration algorithm of an arbiter according to a process to be executed.

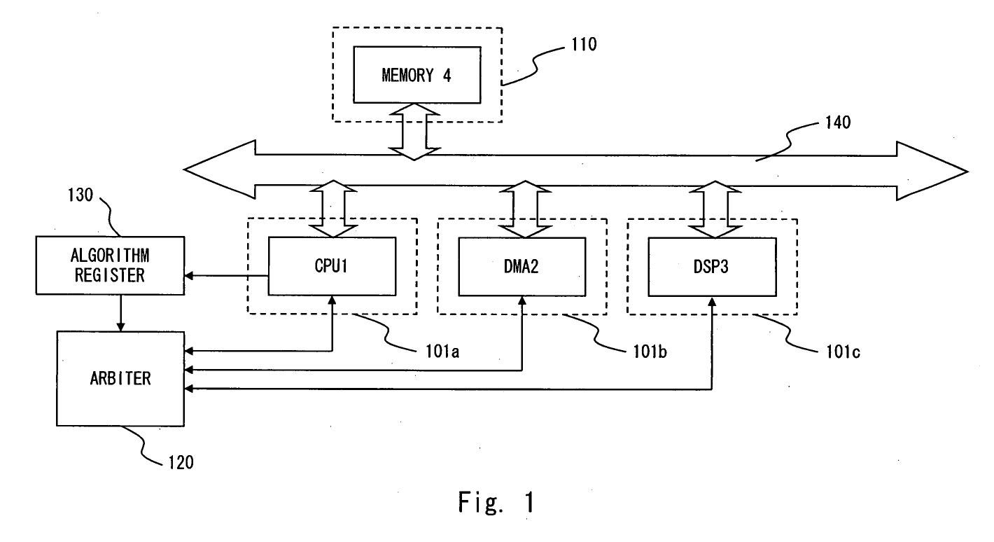

A hardware configuration of the bus control system of this embodiment is described hereinafter in detail with reference to FIG. 1. The bus control system is for example a system LSI constituted of one or a plurality of chips, that is provided to an electronic equipment such as a personal computer, information processing unit, and a cellular phone.

As shown in FIG. 1, the bus control system includes bus masters 101a, 101b, and 101c, a bus slave 110, an arbiter 120, an algorithm register 130. The bus masters 101a, 101b, and 101c, and the bus slave 110 are commonly connected to a bus 140.

The bus masters 101a, 101b, and 101c make requests to use the bus to the arbiter 120. If they are allowed to use the bus by the arbiter 120, they transfer data to the bus slave 110 via the bus 140.

In this example the bus master 101a is a CPU (system control unit) 1 for controlling an operation of an overall system. The bus masters 101b and 101c are auxiliary function units for performing various operations under control of the CPU 1. The bus master 101b is for example a DMA (Direct Memory Access) 2 to directly transfer data for communication with outside to a memory. The bus master 101c is a DSP (Digital Signal Processor) 3 for processing audio and image data. The bus slave 110 is a memory (storage unit) 4 such as RAM for storing information necessary to operate the CPU 1, the DMA 2, and DSP 3. The memory 4 stores a program and calculation data to be executed by the CPU 1, external data for the DMA 2, and audio and image data for the DSP 3, for example.

For example when the bus control system performs a call in a cellular phone, a program for a call is executed in the CPU 1, an audio entered by a user is converted to an audio data in the DSP 3, and the audio data is stored to the memory 4. After the audio data is processed by the CPU 1, it is transferred to outside by the DMA 2. An audio data received from outside is stored to the memory 4, processed by the CPU 1, converted into audio in the DSP 3, and finally outputted to the user.

The algorithm register 130 specifies an arbitration algorithm for the arbiter 120 to arbitrate use of the bus. The arbitration algorithm is for selecting a bus master according to a certain factor (element) so as to perform an arbitration. The arbitration algorithm specifies an order for the bus arbiter to grant the bus masters to use the bus, that is, an order to provide a right to use the bus, according to specified factors (elements). Either the fixed priority method or the round robin method is specified to the algorithm register 130 as an arbitration algorithm. In the fixed priority method, a bus master is elected according to a factor of a priority. In the round robin method, a bus master is selected according to a predetermined order instead of the priority (non-priority method). For example, with the round robin method, “0” is specified, and with the fixed priority method, “1” is specified. In this embodiment, the CPU 1, a system control unit, specifies an arbitration algorithm to the algorithm register 130 based on a process to be executed. In other words, the CPU 1 operates as an arbitration algorithm control unit for switching to a different arbitration algorithm.

The arbiter 120 performs a bus arbitration according to any one of a plurality of different arbitration algorithms. In this embodiment, the arbiter 120 performs a bus arbitration according to an arbitration algorithm specified to the algorithm register 130. To be more specific, in response to bus usage requests from the bus masters 101a, 101b, and 101c, the arbiter 120 selects a bus master according to the round robin method or the fixed priority method that is specified to the algorithm register 130, so as to grant to use the bus.

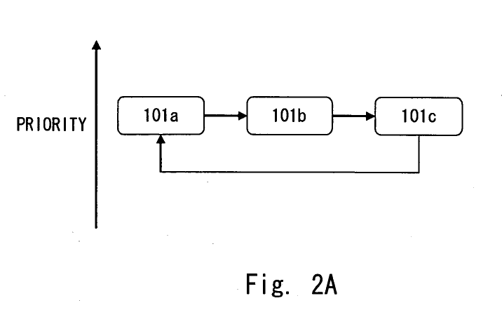

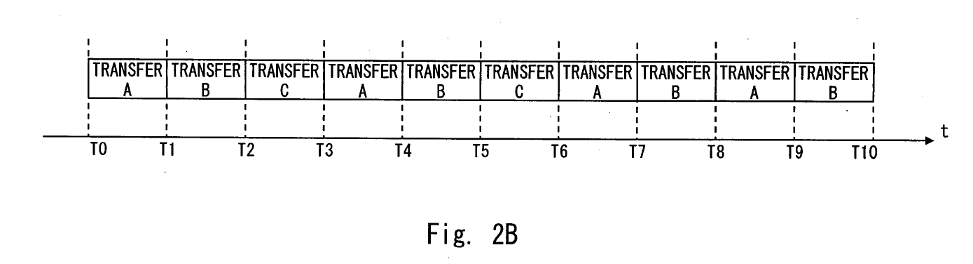

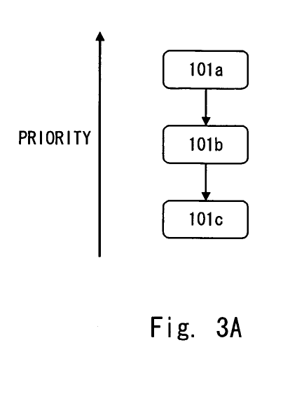

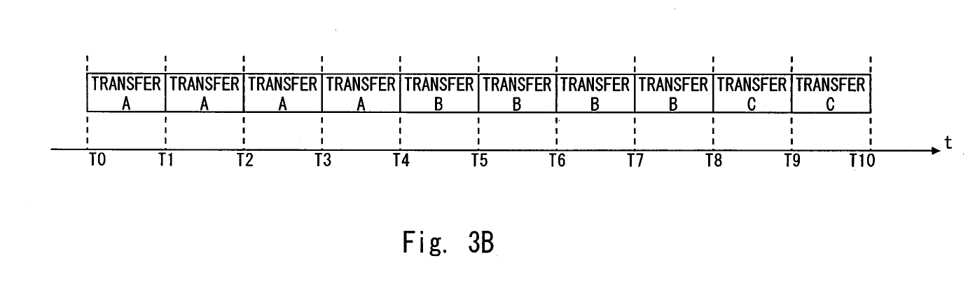

Arbitration algorithms used by the arbiter 120 of this embodiment, that is, arbitration algorithms specified to the algorithm register 130 by the CPU 1, are described hereinafter in detail with reference to FIGS. 2A to 3B.

FIGS. 2A and 2B show an example in a case an arbitration algorithm is the round robin method. FIG. 2A shows an order in which each bus master is selected and granted to use a bus with the round robin method. In the round robin method, priority levels are equal to all the bus masters, and the bus masters are granted to use a bus at the same rate. That is, the bus masters are repeatedly selected to use a bus in order of 101a, 101b, and 101c, at a specified unit. As an example, the next bus master is selected by each data transfer unit.

FIG. 2B shows an example in which an arbitration is performed according to the round robin method to transfer data. For example, four bus usage requests to transfer data A are generated from the bus master 101a. Four bus usage requests to transfer data B are generated from the bus master 101b. Two bus usage requests to transfer data C are generated from the bus master 101c. With the round robin method, the bus masters are granted to use the bus in order of 101a, 101b, and 101c, and the data are transferred in order of A, B and C (T0 to T3). After the bus masters 101a to 101c are granted to use the bus, the data C for the bus master 101c is completed to be transferred (T3 to T6). After that, the bus masters 101a and 101b are repeatedly granted to use the bus, and all of the data A and B are transferred (T6 to T10). As shown in FIG. 2B, if the round robin method is used for an arbitration algorithm, data is equally transferred from each bus master, and the data A and B are completed to be transferred at close timings (T9 and T10).

FIGS. 3A and 3B show an example in which an arbitration is performed according to the round robin method. FIG. 2A shows an order in which bus masters are granted to use a bus with the fixed priority method. In the fixed priority method, each bus master is specified with a different priority level, and a bus master with a higher priority is preferentially granted to use the bus. In other words, a bus master with the highest priority is selected first, and after processing all processes of the bus master, a bus master with the second highest priority is selected. In this example, a priority of the bus master 101a is the highest, that of the bus master 101b is the second highest, and that of the bus master 101c is the lowest. The priorities may be specified to the arbiter 120 in advance or the CPU 1 may specify the priorities to the algorithm register 130.

FIG. 3B shows an example in which an arbitration is performed according to the fixed priority method to transfer data. Bus usage requests generated from each bus master are the same as in FIG. 2B. In the fixed priority method, the bus master 101a having the highest priority is repeatedly granted to use the bus, and data A is completed to be transferred (T0 to T4). Then the bus master 101b having the second highest priority is repeatedly granted to use the bus, and data B is completed to be transferred (T4 to T8). Then the bus master 101c having the third highest priority is repeatedly granted to use the bus, and data C is completed to be transferred (T8 to T10). As shown in FIG. 3B, if the fixed priority method is used for an arbitration algorithm, data is preferentially transferred from the bus masters having higher priority, resulting in data A being completed to be transferred first. In the round robin method as shown in FIG. 2B, the data A is completed to be transferred by T9, while in the fixed priority method, the data A is completed to be transferred by T4.

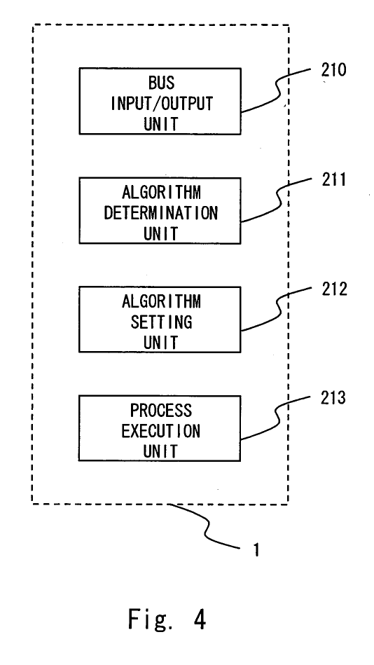

Functional blocks of the CPU 1, a system control unit (an arbitration algorithm control unit), are described hereinafter in detail with reference to FIG. 4. Each block in FIG. 4 is constituted of hardware for the CPU 1 or software to be executed in the hardware. For example the CPU 1 performs a process according to a program stored in the memory 4, realizing functions of each block in cooperation with hardware.

As shown in FIG. 4, the CPU 1 includes a bus input/output unit 210, an algorithm determination unit 211, an algorithm setting unit 212, and a process execution unit 213.

The bus input/output unit 210 inputs/outputs data with the bus 140. To use the bus 140, a bus master firstly outputs a bus usage request to the arbiter 120, waits for a grant to use the bus, and performs data transfer via the bus 140.

The algorithm determination unit 211 reads a program to be executed by the bus input/output unit 210 from the memory 4. Then, the algorithm determination unit 211 identifies the characteristics of the process to be executed and determines the appropriate arbitration algorism for the process.

The algorithm setting unit 212 specifies the information indicating of the arbitration algorithm determined by the algorithm determination unit 21 to the algorithm register 130.

The process execution unit 213 executes a process of the program read from the memory 4. For example the process execution unit 213 performs various calculations according to the program, data transfer with the memory 4, or controls an operation of the DMA 2 and DSP 3.

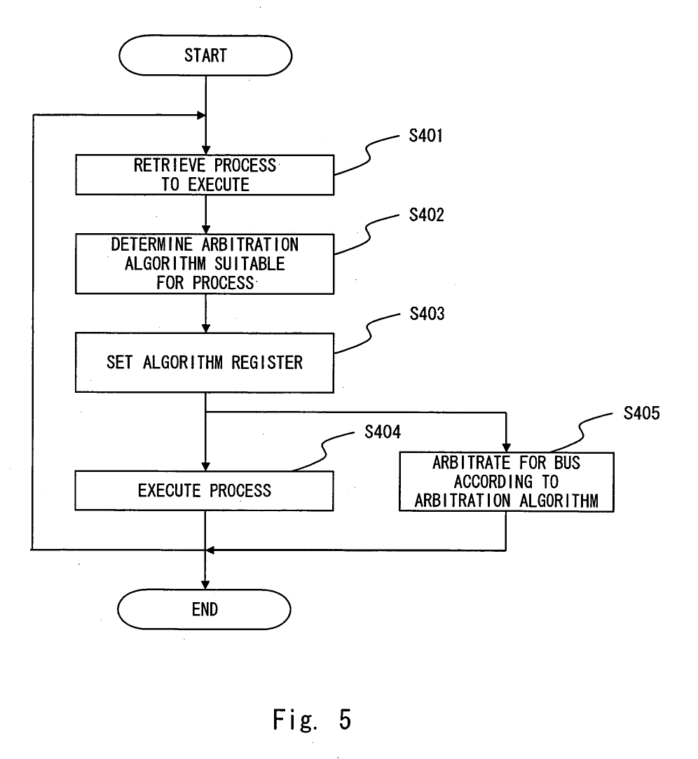

A bus control process of the bus control system of this embodiment is described hereinafter in detail with reference to a flow chart of FIG. 5. For example when a user launches a certain application program including a call, videophone, and an e-mail, the bus control process is started.

The CPU 1 performs steps S401 to S404 described hereinafter. Firstly the algorithm determination unit 211 retrieves a process to be executed (S401). A program for processing user operation and necessary data are inputted to the process evaluation 211 from the memory 4.

Then the algorithm determination unit 211 determines an arbitration algorithm suitable for the process retrieved in the S401 (S402). For example the algorithm determination unit 211 determines whether a most appropriate arbitration algorithm is the round robin method or the fixed priority method according to the program or data read from the memory 4. Details of the determination process of the arbitration algorithm are described later.

Then the algorithm setting unit 212 specifies the arbitration algorithm determined in the S402 to the algorithm register 130 (S403). In a case an arbitration algorithm determined by the algorithm determination unit 211 is the round robin method, the algorithm setting unit 212 specifies “0” to the algorithm register. In a case an arbitration algorithm is the fixed priority method, the algorithm setting unit 212 specifies “1” to the algorithm register 130.

Then the process execution unit 213 executes the process retrieved in the S401 (S404). The process execution unit 213 executes a process according to the program or data read from the memory 4. When the algorithm register 130 is specified in the S403, the arbiter 120 arbitrates use of the bus according to the specified arbitration algorithm (S405). Specifically, as shown in FIGS. 2A to 3B, the arbiter 120 arbitrates and data is transferred by respective bus masters.

If a process is executed in S404, for example the CPU 1, the DMS2, and the DSP 3 output bus usage requests to the arbiter 120 in order for the CPU 1 to process data in the memory 4, the DMA 2 to transfer external data to the memory 4, or the DSP 3 to convert audio data in the memory 4. If the algorithm register 130 is “0”, the arbiter 120 grants the bus usage request with the round robin method. If the algorithm register 130 is “1”, the arbiter 120 grants the bus usage request with the fixed priority method. The CPU 1, the DMA 2, and the DSP 3 perform data transfer to the memory 4 using the bus 140, in order of being granted.

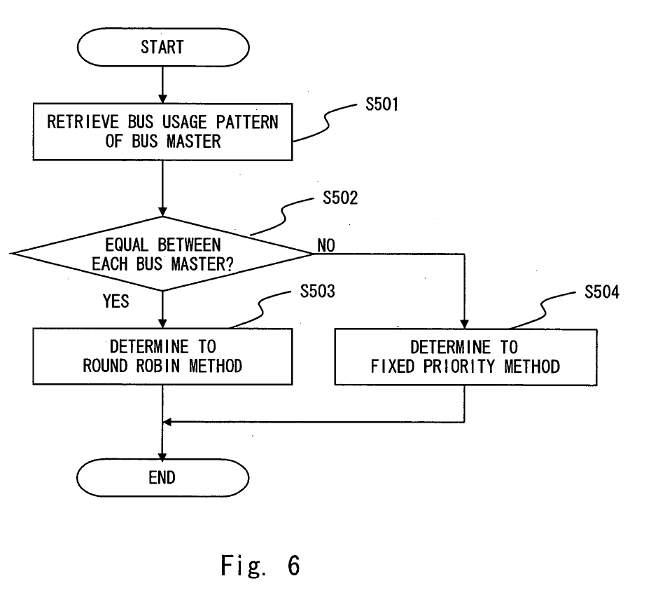

A determination process of the arbitration algorithm shown in the S402 of FIG. 5 is described hereinafter in detail with reference to a flow chart of FIG. 6. The determination process is for the algorithm determination unit 211 of the CPU 1 to determine an arbitration algorithm suitable for a process to be executed.

Firstly the algorithm determination unit 211 obtains bus usage patterns of each bus master (S501). For example the algorithm determination unit 211 obtains a process pattern, that is, a pattern for each bus master to use a bus when executing a process, as an element to determine an appropriate arbitration algorithm. A usage pattern of a bus includes a probability to use a bus, an amount of data to transfer, and a data transfer frequency, for example. Other than the above elements, the usage pattern may include a characteristic of data such as whether a delay can be granted and the data may need to be transferred consecutively.

Then the algorithm determination unit 211 evaluates whether the bus usage pattern obtained in the S501 is equal/unequal between the bus masters (S502). As a reference to evaluate an arbitration algorithm, the algorithm determination unit 211 evaluates whether the bus usage patterns are equal/unequal, that is, evaluates whether each bus master uses a bus in an almost the same pattern. Specifically, the algorithm determination unit 211 evaluates whether a bus usage probability and an amount of data transfer is almost the same or not.

If the bus usage pattern is evaluated to be almost equal in the S502, the algorithm determination unit 211 determines the arbitration algorithm to be the round robin method (S503). For example if the probabilities of each bus master to use the bus and other factors are almost the same, in other words, if the bus is equally used by each bus master, the algorithm determination unit 211 determines the arbitration algorithm to be the round robin method. To be more specific, in a case data transfer is performed equally from each bus master as in FIG. 2B, and a timing for a completion of data A transfer of the bus master 101a can be T9, the arbitration algorithm is specified to the round robin method.

If the bus usage pattern is evaluated to be unequal in the S502, the algorithm determination unit 211 determines the arbitration algorithm to be the fixed priority method (S504). For example if the probabilities of each bus master to use the bus and other factors are different, or if data needs to be transferred before other bus masters, that is, in a case a specified bus master preferentially uses the bus, the algorithm determination unit 211 determines the arbitration algorithm to be the fixed priority method. To be more specific, if data needs to be preferentially transferred from the bus master 101a and the transfer needs to be completed by T4 as shown in FIG. 3B, the arbitration algorithm is determined to be the fixed priority method.

As described in the foregoing, in this embodiment, a set value of the register is changed and an arbitration algorithm for an arbiter is switched depending on a process to be executed. In a case in which each bus master is equally processed, the arbitration algorithm is determined to be the round robin method (the round robin algorithm). On the other hand in a case in which a specified bus master is preferentially processed, the arbitration algorithm is determined to be the fixed priority method (the fixed priority algorithm). Applying the present invention to a cellular phone enables to choose an arbitration algorithm suitable for an application such as a call, videophone, and an e-mail.

By switching arbitration algorithms instead of switching priority within one arbitration algorithm as in a conventional technique, it is more flexible to specify an order of arbitrating use of the bus, thereby enabling to arbitrate in a more appropriate order. It is therefore possible to efficiently use the bus and to reduce time for waiting a data transfer. As a result it greatly reduces overrun/underline generated due to the bus masters waiting to use the bus. Further, if the bus master includes a FIFO memory for storing data waiting to be transferred, an amount of FIFO memory can be reduced by reducing the transfer waiting time.

Further, by specifying an arbitration algorithm to be used when bus masters are most loaded, a probability to use a bus can be calculated, so that an amount of FIFO memory provided to the bus masters can easily be estimated. For example, if a probability of the DMA, that is a bus master, being capable of using the bus is ¼ at worst before applying the present invention, using the ½ fixed priority method according to the invention can reduce the amount of FIFO memory by half.

Waiting time for data transfer can also be reduced, therefore the time to complete a process of each bus master is shortened as well. Accordingly in a redundant configuration system having a subsystem such as a multiprocessor, power consumption can be reduced by stopping clocks of a CPU that completed a process and by switching to a power saving mode.

Further, in a method in which a hardware is to monitor usage of a bus as in a conventional technique, a monitor circuit is additionally required. However in this embodiment, by using a software control, it is possible to restrain from increasing a circuit size and also to facilitate the control even for a large system having a large amount of bus masters.

Furthermore with a hardware control, only a case when a monitor circuit etc detects predetermined conditions can be controlled, thereby guaranteeing only the minimum throughput of bus masters. With this embodiment, as an arbitration algorithm is switched in advance before executing a process, it is not necessary to wait until the monitor circuit detects predetermined conditions in order to arbitrate for the bus using a most appropriate method, helping to improve an efficiency of the bus usage.

Particularly in this embodiment, it is possible to control with more flexible conditions by using software to control instead of hardware. To be more specific, for a process that needs to guarantee the minimum throughput, an arbitration algorithm to satisfy the condition can be selected. For a process that other bus masters are able to wait for a long time, an arbitration algorithm that guarantees the maximum throughput can be selected.

### Second Embodiment

A bus control system according to a second embodiment of the present invention is described hereinafter in detail. A bus control system of this embodiment is characterized in that it groups a plurality of bus masters and switches arbitration algorithms between and within the groups depending on processes to be executed.

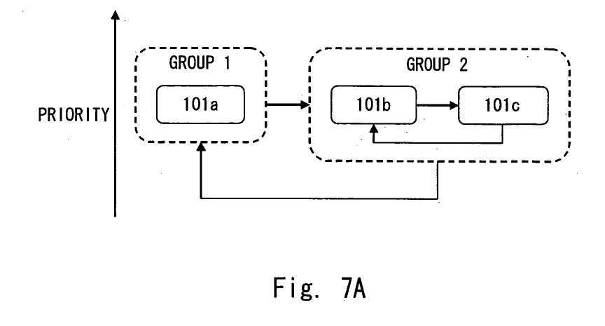

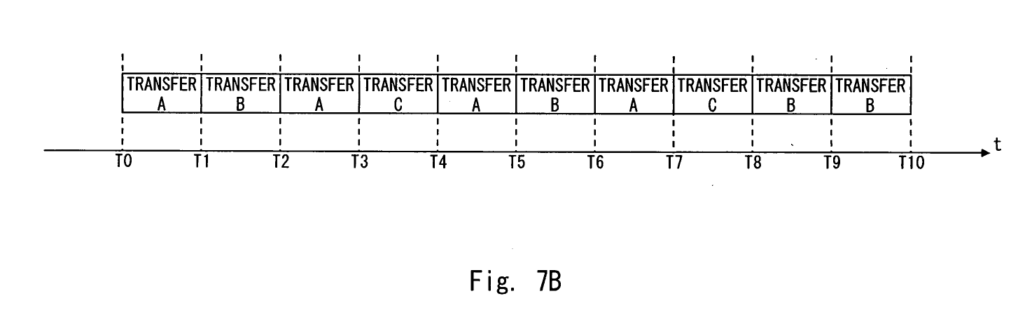

A simple example of an arbitration algorithm when grouping bus masters is described here, for a comparison to the first embodiment. FIGS. 7A and 7B show an example of arbitrating use of a bus between the bus masters 101a, 101b, and 101c, as with FIGS. 2A to 3B.

FIG. 7A is an example of grouping the bus masters 101a to 101c into two groups to arbitrate. In this example, the bus master 101a is grouped to a group 1, and bus masters 101b and 101c are grouped to a group 2. In this embodiment, two arbitration algorithms are specified, which are; an arbitration algorithm between groups to determine an arbitration order (an order to grant a bus usage request), and an arbitration algorithm in a group to determine an arbitration order of each bus masters in the group. For example an arbitration algorithm for arbitrating the groups 1 and 2 is specified to be the round robin method, and an arbitration algorithm for arbitrating the bus master 101b and the bus master 101c is specified to be the round robin method. In this case, the groups 1 and 2 are repeatedly selected in this order. If the group 1 is selected, the bus master 101a is granted to use the bus. If the group 2 is selected, either the bus master 101b or the bus master 101c is repeatedly selected to be granted to use the bus.

FIG. 7B is a specific example in which data is transferred according to the arbitration algorithms in FIG. 7A. Bus usage requests generated from each bus master are the same as in FIG. 2B. In this method, the bus master 101a and the bus master 101b or 101c are selected, and data is transferred in order of A, B, A, and C (T0 to T4). In a similar manner, the data A, B, A, and C are transferred and the data A and C of the bus masters 101a and 101c are completed (T4 to T8). Then the bus master 101b is repeatedly selected and the data B is completed to be transferred (T8 to T10). As in FIGS. 2B and 3B, the data A is completed to be transferred by T9 with the round robin method, and with the fixed priority method, the data A is completed to be transferred by T4. However in this method, the data A is completed to be transferred by T7 as shown in FIG. 7B. Accordingly as compared to a simple round robin method or fixed priority method in the first embodiment, the second embodiment allows more detailed adjustment depending on a process.

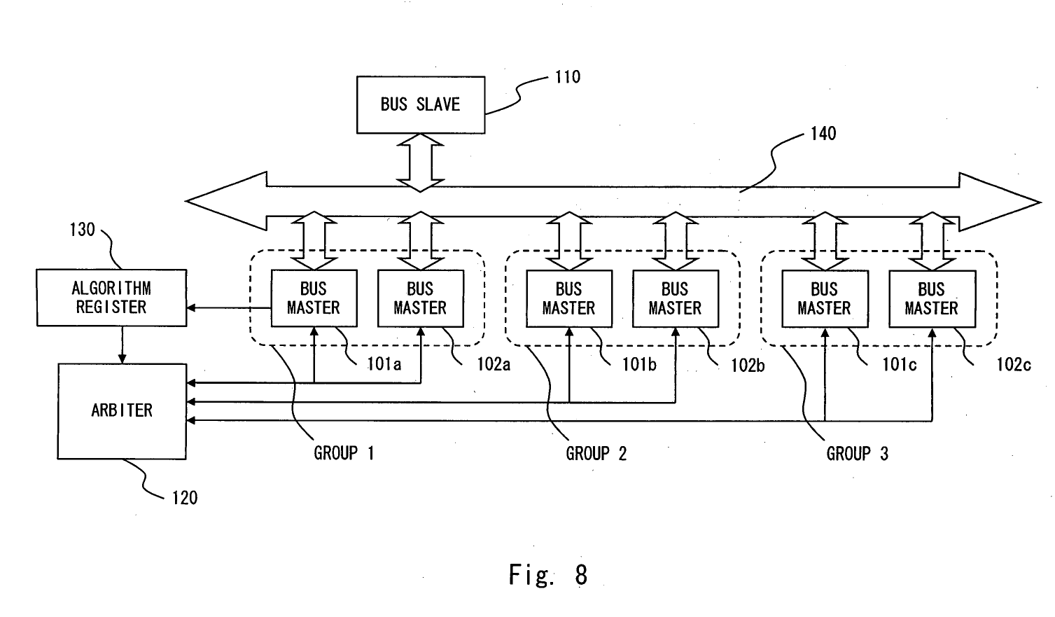

A hardware configuration of the bus control system of this embodiment is described hereinafter in detail with reference to FIG. 8. In FIG. 8, components identical to those in FIG. 1 are denoted by reference numerals identical to those therein with detailed description omitted.

In addition to the components in FIG. 1, the bus control system includes bus masters 102a, 102b, and 102c. Each bus master is commonly connected to a bus 140. For example the bus master 102a is a CPU as with the bus master 101a. The bus master 102b is a DMA as with the bus master 101b. The bus master 102c is a DSP as with the bus master 101c.

FIG. 8 is an example of grouping the six bus masters into three groups. In this example, the bus masters 101a and 102a are grouped to be a group 1. The bus masters 101b and 102b are grouped to be a group 2. The bus masters 101c and 102c are grouped to be a group 3. The groups are units that arbitration algorithms are specified. The group that a bus master belongs thereto may be specified to the arbiter 120 in advance or the CPU may specify to the algorithm register 130.

The bus master 101a is a CPU 1 for controlling an overall system as in the first embodiment, with the same functional blocks as in FIG. 4. A bus control process is the same as the FIG. 5. In this embodiment, each block of the CPU 1 specifies an arbitration algorithm between the groups and an arbitration algorithm within group to the algorithm register 130. In other words, the CPU 1 is an arbitration algorithm control unit for switching arbitration algorithms between and within groups.

For example suppose that several bits of data is specified to the algorithm register 130. To a first bit, “0” indicating of the round robin method or “1” indicating of the fixed priority method is specified as an arbitration algorithm between groups is specified. From the second bit onwards, “0” indicating of the round robin method or “1” indicating of the fixed priority method is specified for each group as an arbitration algorithm within a group. The arbiter 120 arbitrates an order of using a bus between the groups according to the specified arbitration algorithm. For example the arbiter 120 refers to the algorithm register 130, and if the first bit is “0”, the arbiter 120 arbitrates between groups according to the round robin method. If the first bit is “1”, the arbiter 120 arbitrates between groups according to the fixed priority method. If bits after the first bit are “0”, an arbitration in the group is performed with the round robin method. If bits after the first bit are “1”, an arbitration in the group is performed with the fixed priority method.

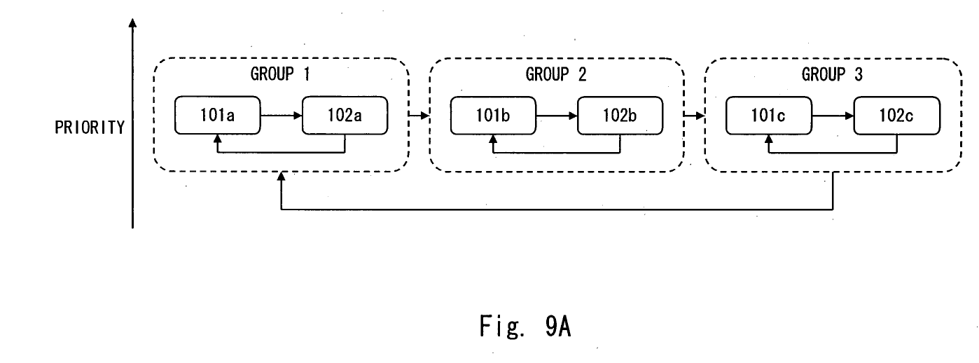

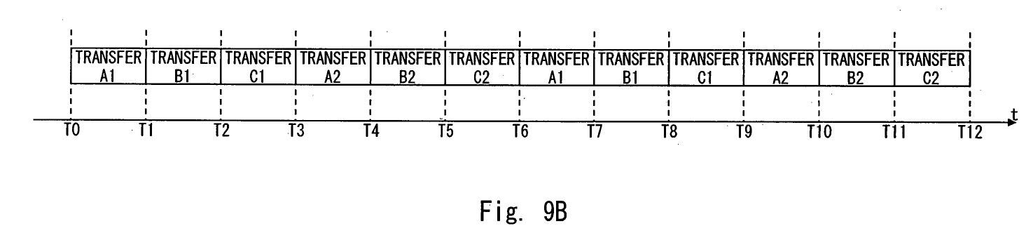

An arbitration algorithm used in the arbiter 120 of this embodiment, that is, an arbitration algorithm that the CPU 1 specifies to the algorithm register 130, is described hereinafter in detail with reference to FIGS. 9A to 12B.

FIGS. 9A and 9B show an example in which an arbitration algorithm between groups is specified to be the round robin method, and an arbitration algorithm within the groups are also specified to be the round robin method. FIG. 9A shows an order where each bus master is selected to be granted to use a bus according to the arbitration algorithms. In this method, priority levels between the groups are equal, and priority levels between bus masters within the groups are equal as well. Thus each group is granted to use the bus at the same rate, and each bus master is also granted to use the bus at the same rate.

In this method, groups 1, 2, and 3 are repeatedly selected in this order, and bus masters in each group is selected one by one. As each group is selected, one of bus masters in the group is selected to be granted to use the bus.

FIG. 9B shows an example in which an arbitration is performed with the method in FIG. 9A to transfer the data. For example suppose that two bus usage requests each from the bus masters 101a and 102a to transfer data A1 and A2 are generated, two bus usage requests each from the bus masters 101b and 101b to transfer data B1 and B2 are generated, and two bus usage requests each from the bus masters 101c and 102c to transfer data C1 and C2 are generated.

In this method, the bus master 101a from the group 1, the bus master 101b from the group 2, and the bus master 101c from the group 3 are selected in this order. Then the bus master 102a from the group 1, the bus master 102b from the group 2, and the bus master 102c from the group 3 is selected in this order. As a result, data A1, B1, C1, A2, B2, and C2 is transferred in this order (T0 to T6). The bus masters are selected to be granted to use the bus in the similar manner, and the data A1, B1, C1, A2, B2, and C2 are transferred in this order, consequently completing all the data transfer (T6 to T12).

As shown in FIG. 9B, if the arbitration algorithm between and within the groups are specified to be the round robin method, it is possible to not only equally transfer data from each group but also equally transfer data from each bus masters in the groups. In this case, the data A2, B2, and C2 from the groups 1 to 3 are completed to be transferred at close timings (T10 to T12) while in the group 1, the data A1 and A2 are completed to be transferred at close timings (T7 and T10).

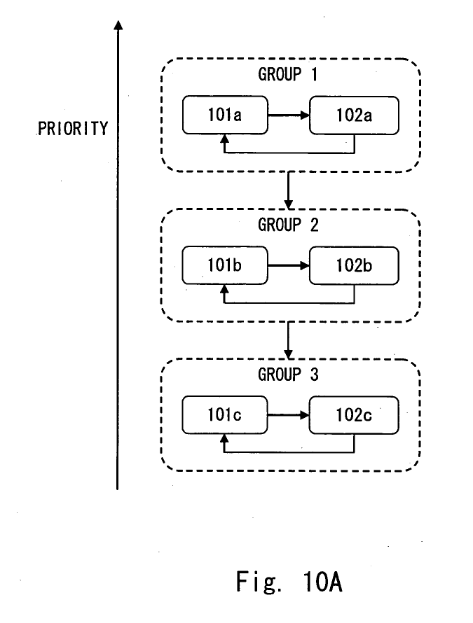

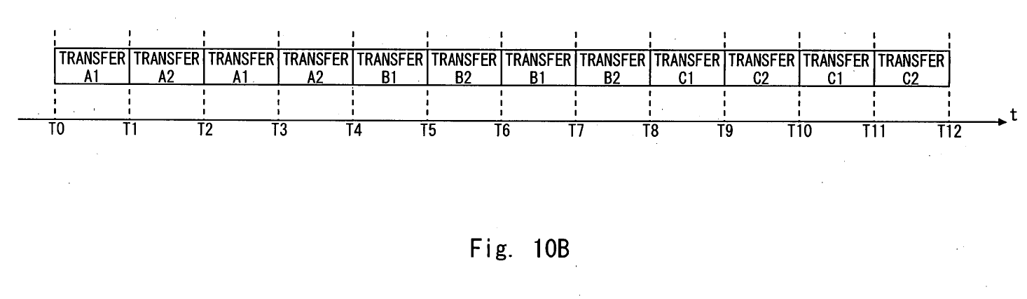

In FIGS. 10A and 10B, an arbitration algorithm between the groups are specified to be the fixed priority method, while an arbitration algorithm within the group is specified to be the round robin method. FIG. 10A shows an order in which the bus masters are granted to use a bus according to this method. With this method, different priority levels are specified between groups but the priority levels between bus masters in the groups are equal. Therefore the groups with higher priority are preferentially granted to use a bus, while the bus masters in the group are granted to use the bus at the same rate.

In other words, with this method, the group with the highest priority is selected first, and after completing processes of the bus masters in that group, the group with the second highest priority is selected. When a group is selected, each bus master in the group is repeatedly selected to be granted to use the bus. In this example, the priority of the group 1 is the highest, that of the group 2 is the second highest, and that of the group 3 is the lowest.

FIG. 10B shows an example in which an arbitration is performed with the method in FIG. 10A to transfer the data. Bus usage requests generated from each bus master are the same as in FIG. 9B. In this method, for the group 1 having the highest priority, the bus is granted to be used in order of the bus master 101a and 102a to complete data transfer of the data A1 and A2 (T0 to T4). Then for the group 2 having the second highest priority, the bus is granted to be used in order of the bus master 101b and 102b, completing data transfer of the data B1 and B2 (T4 to T8). Then for the group 3 having the third highest priority, the bus is granted to be used in order of the bus master 101c and 102c to complete data transfer of the data C1 and C2 (T8 to T12).

As shown in FIG. 10B, in a case an arbitration algorithm between the groups is specified to be the fixed priority method, and an arbitration algorithm within the group is specified to be the round robin method, a group with a higher priority is preferentially selected to perform data transfer and each bus master in the group is equally selected to perform data transfer. In this case, data transfer for the group 1 is completed by T4, faster than the other groups. Within the group 1, the data A1 and A2 are completed to be transferred at close timings (T3 and T4).

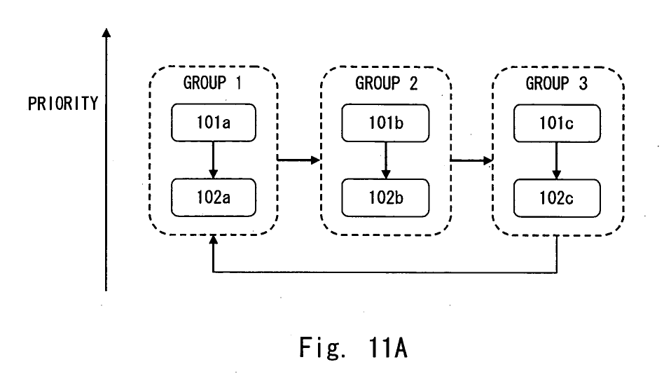

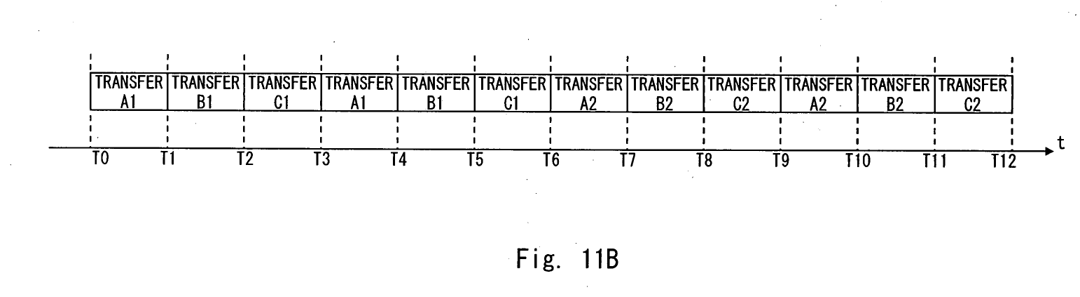

FIGS. 11A and 11B show an example in which an arbitration algorithm between the groups is specified to be the round robin method, and an arbitration algorithm within the groups is specified to be the fixed priority method. FIG. 11A shows an order in which the bus is granted to be used with this method. With this method, priority levels between groups are equal, while priority levels within the groups are different. Accordingly the bus is granted to be used to the groups at the same rate, while within the groups, bus masters with higher priority are preferentially granted to use the bus.

In other words, with this method, groups 1, 2, and 3 are repeatedly selected in this order, and bus masters in each group is selected one by one. As a group is selected, bus master with a higher priority within the group is selected. If all the processes of the bus master with a higher priority are completed, a bus master having the next highest priority is selected. In this example, the bus master 101a has the highest priority, the bus master 102a has the second highest priority within the group 2. Within the group 2, the bus master 101b has the highest priority, and the bus master 102b has the second highest priority. Within the group 3, the bus master 101c has the highest priority, and the bus master 102c has the second highest priority.

FIG. 11B shows an example in which an arbitration is performed using the method in FIG. 11A to transfer data. Bus usage requests generated from each master are the same as in FIG. 9B. In this method, bus masters are selected in order of the group 1, 2, and 3. The bus master 101a having a higher priority in the group 1 is selected once, the bus master 101b having higher priority in the group 2 is selected once, and the bus master 101c having higher priority in the group 3 is selected once to be granted to use the bus. Then the data A1, B1 and C1 are completed to be transferred (T0 to T6). Further, the bus master 102a having lower priority in the group 1 is selected once, the bus master 102b having lower priority in the group 2 is selected once, and the bus master 102c having lower priority in the group 3 is selected once to be granted to use the bus. Then the data A2, B2 and C2 are completed to be transferred (T6 to T12).

As shown in FIG. 11B, in a case an arbitration algorithm between the groups is specified to be the round robin method, and an arbitration algorithm within the groups is specified to be the fixed priority method, each group is equally selected to perform data transfer, while within a group, bus master having higher priority is preferentially selected to transfer data. In this case, the data A2, B2, and C3 in the groups 1 to 3 are completed to be transferred at close timings (T10 to T12), and in the group 1, the data A1 is completed to be transferred at T4, faster than the data A2.

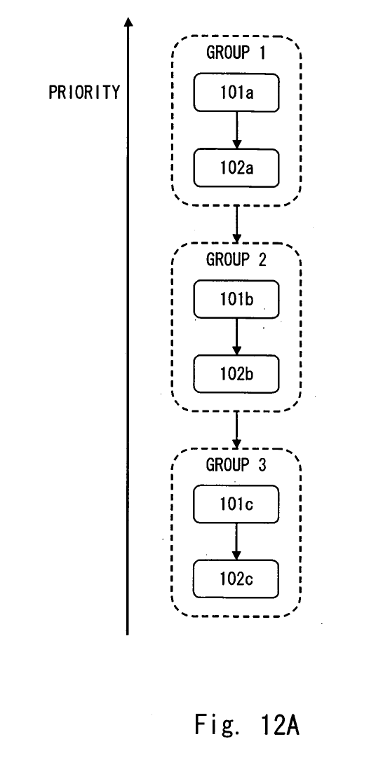

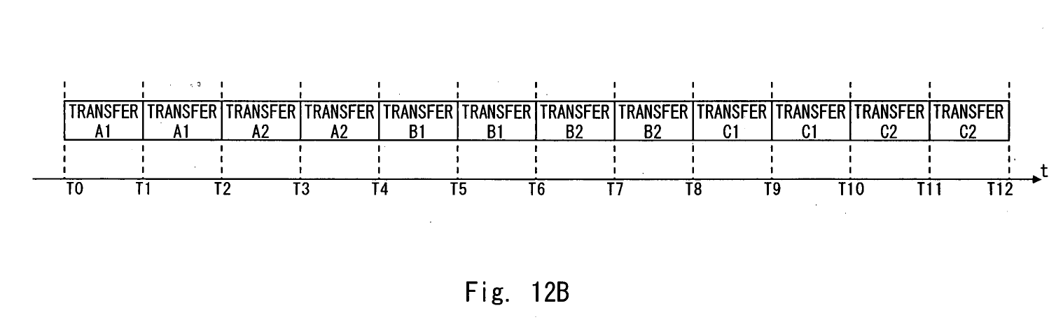

FIGS. 12A and 12B show an example in which an arbitration algorithm between the groups is specified to be the fixed priority method, and an arbitration algorithm within the groups is also specified to be the fixed priority method. FIG. 12A shows an order in which a bus is granted to be used using this method. With this method, priority levels between groups are different, and priority levels between bus masters within the groups are different as well. Accordingly a group having a higher priority is preferentially granted to use a bus, and a bus master having a higher priority within the group is preferentially granted to use the bus.

In other words with this method, a group with the highest priority is selected first, and after completing all the processes of the bus master in the group, a group having the next highest priority is selected. When a group is selected, a bus master having a higher priority is selected, and after completing all the processes of the bus master, a bus master having the next highest priority is selected. In this example, the group 1 has the highest priority, the group 2 has the second highest priority, and the group 3 has the lowest priority. Within the group 1, the bus master 101a has the highest priority and the bus master 102a has the second highest priority. Within the group 2, the bus master 101b has the highest priority and the bus master 102b has the second highest priority. Within the group 3, the bus master 101c has the highest priority and the bus master 102c has the second highest priority.

FIG. 12B shows an example in which an arbitration is performed with the method in FIG. 12A to transfer data. Bus usage requests generated from each bus master re the same as in FIG. 9B. With this method, as for the group 1 having the highest priority, firstly the bus master 101a with a higher priority is repeatedly selected to complete transferring the data A1. Then the bus master 102 with a lower priority is repeatedly selected to complete transferring the data A2 (T0 to T4). As for the group 2 having the second highest priority, firstly the bus master 101b with a higher priority is repeatedly selected to complete transferring the data B1. Then the bus master 102b with lower priority is selected to complete transferring the data B2 (T4 to T8). After that for the group 3 having the third highest priority, firstly the bus master with a higher priority is repeatedly selected to complete transferring the data C1. Then the bus master 102c with a lower priority is selected to complete transferring the data C2 (T8 to T12).

As shown in FIG. 12B, in a case arbitration algorithms between and within the groups are specified to be the fixed priority method, a group with a higher priority is preferentially selected to perform data transfer, and a bus master with a higher priority within the group is preferentially selected to perform data transfer. In this case, a data transfer for the group 1 is completed by T4, faster than the other groups. Within the group 1, data transfer for the data A1 is completed at T2, faster than the data A2.

Although in this embodiment, the arbitration algorithm within the group is specified to be the same for all the groups, different arbitration algorithms may be specified to each group. Furthermore, a plurality of groups (subgroups) may be formed in one group to be a hierarchical structure, and arbitration algorithms may be specified to each subgroup and hierarchy.

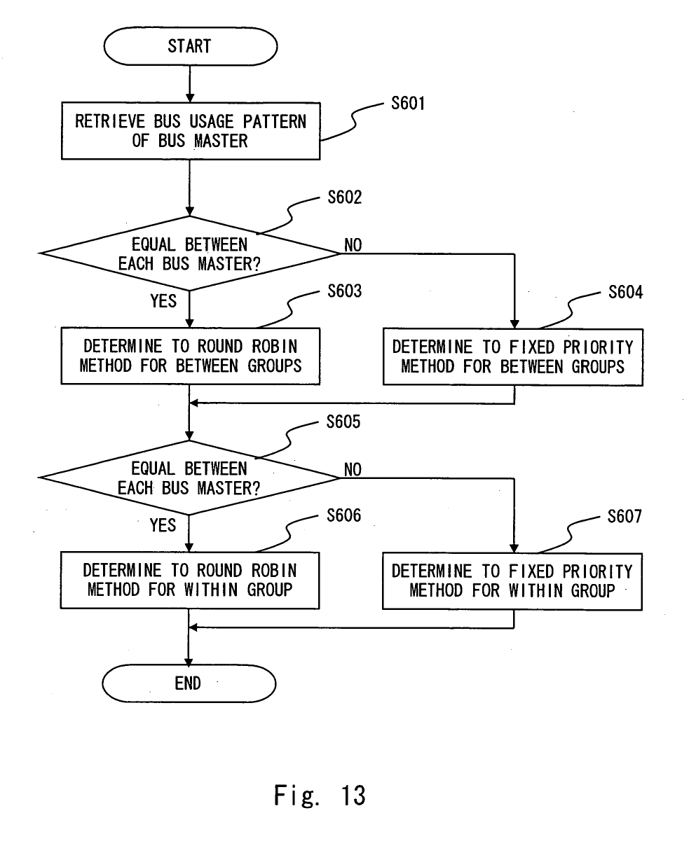

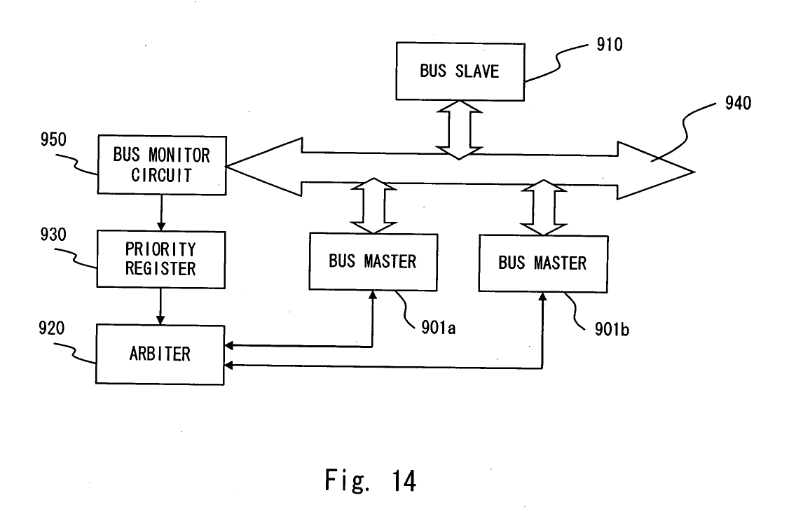

A determination process of this embodiment is described hereinafter in detail with reference to a flow chart of FIG. 13. The determination process is the process in the S402 of FIG. 5 as with the FIG. 6, in which the algorithm determination unit 211 of the CPU 1 determines an arbitration algorithm suitable for a process to be executed. Factors to determine the arbitration algorithm is the same as the first embodiment.

Firstly the algorithm determination unit 211 obtains a bus usage pattern of each bus master (S601) In this example, the algorithm determination unit 211 obtains a bus usage pattern of each group, in addition to a bus usage pattern of each bus master. For example a bus usage probability and an amount of data transfer for each group are calculated from a bus usage probability and an amount of data transfer for each bus master.

Then the algorithm determination unit 211 evaluates whether the bus usage patterns obtained in the S601 are equal/unequal between the groups (S602). If the bus usage patterns are equal, the algorithm determination unit 211 determines an arbitration algorithm between groups to be the round robin method (S603). If the bus usage patterns are unequal, the algorithm determination unit 211 determines an arbitration algorithm between groups to be the fixed priority method (S604). For example, if bus usage probability and other factors of each group are almost the same, the algorithm determination unit 211 specifies an arbitration algorithm between groups to be the round robin method. Specifically, in a case in which data transfer can be performed at the same rate in each group as in FIG. 9B and FIG. 11B, and the data A1 and A2 in the group 1 may be completed to be transferred at T10, the arbitration algorithm is specified to be the round robin method. Further, if bus usage probability and other factors of each group are different, the algorithm determination unit 211 specifies an arbitration algorithm between groups to be the fixed priority method. To be more specific, in a case in which data transfer needs to be preferentially performed from the group 1, and the data A1 and A2 in the group 1 need to be completed by T4, the arbitration algorithm is specified to be the fixed priority method.

Then, the algorithm determination unit 211 evaluates whether the bus usage patterns obtained in the S601 are equal/unequal between the bus masters in each group (S605). If the bus usage patterns are equal, the algorithm determination unit 211 determines an arbitration algorithm within a group to be the round robin method (S606). If the bus usage patterns are unequal, the algorithm determination unit 211 determines an arbitration algorithm within a group to be the fixed priority method (S607). For example, if bus usage probability and other factors of each bus master in the group are almost the same, the algorithm determination unit 211 specifies an arbitration algorithm within the group to be the round robin method. Specifically, in a case in which data transfer may be performed at the same rate for each bus master in the group as in FIG. 9B and FIG. 11B, and the data A1 of the bus master 101a may be completed to be transferred at T7 or T3, the arbitration algorithm is specified to be the round robin method. Further, if bus usage probability and other factors of each bus master in the group are different, the algorithm determination unit 211 specifies an arbitration algorithm between groups to be the fixed priority method. To be more specific, if data needs to be preferentially transferred from the bus master 101a, and data transfer for the data A1 of the bus master 101a needs to be completed by T3 or T4 as shown in FIGS. 11B and 12B, the arbitration algorithm is determined to be the fixed priority method.

Although in this example, the arbitration algorithm within the group is determined after determining the arbitration algorithm between the groups, an order of determination is not restricted to the foregoing order. For example the arbitration algorithm between the groups may be determined after determining the arbitration algorithm within the group, or the arbitration algorithm between the groups and the arbitration algorithm in the group may be determined at the same time.

As described so far, in this embodiment, an arbitration algorithm between groups and an arbitration algorithm within the group is switched when switching arbitration algorithms depending on a process to execute. This enables to select more appropriate arbitration algorithm to a pattern of the process. For example in one process, bus masters 101a and 102 are heavily loaded while other bus masters are lightly loaded. In such a process, an arbitration algorithm between the groups is specified to be the fixed priority method to give a preference to the group 1. In another process, bus masters 101a and 102a are heavily loaded, while other bus masters are to be processed equally. In such a process, an arbitration algorithm between the groups is specified to be the fixed priority method, and an arbitration algorithm within the groups is specified to be the round robin method. This embodiment therefore allows for more detailed adjustment compared to the first embodiment and enables more efficient bus usage, accordingly shortening bus waiting time better than the first embodiment.

### Other Embodiment

In the above example, although the arbitration algorithm is switched according to the process to be executed, an order to select the bus masters may be switched within one arbitration algorithm depending on a process to be executed. Priorities of each bus master or group in the fixed priority method may be changed according to a process to be executed. For example a bus master having the highest probability to use a bus may be specified to have the highest priority. In this case, information indicating that an arbitration algorithm is the fixed priority method, and information indicating of priorities of the bus masters and groups is stored to the algorithm register 130. Then the arbiter 120 arbitrates for the bus according to the priorities.

Further, priorities of each bus master or group in the round robin method may be changed according to a process to be executed. For example for bus masters or groups having the same probability to use the bus but one bus master or one group needs to be processed first, it can be specified to be selected first. In this case, information indicating that the arbitration algorithm is the round robin method, and information indicating an order of selecting each bus master or group is stored to the algorithm register 130. Then the arbiter 120 arbitrates for the bus according to the order of selection.

Although in the above example, the round robin method and the fixed priority method are switched as the arbitration algorithms, it may be switched to other algorithm. For example to a method selecting a bus master at random, or a method selecting a bus master in order that a bus usage request is generated.

Further, in the above example, CPU is used to evaluate patterns of processes to be executed to switch the arbitration algorithms. However data indicating of an arbitration algorithm suitable for a process may be stored to the memory 4, so that when starting the process, the CPU does not needs to evaluate the process but refers to the stored data to directly store the data to the algorithm register. For example if a user presses a dial button on a cellular phone, an arbitration algorithm supporting a dial operation is read from the memory to specify the arbitration algorithm.

It is apparent that the present invention is not limited to the above embodiment and it may be modified and changed without departing from the scope and spirit of the invention.

What is claimed is:

1. A bus control system comprising:
a plurality of bus masters commonly connected to a bus;
a bus arbiter for arbitrating use of the bus between the plurality of bus masters according to any one of a plurality of predetermined arbitration algorithms; and
an arbitration algorithm control unit for switching the plurality of arbitration algorithms.

2. The bus control unit according to claim 1, wherein the arbitration algorithm control unit switches the plurality of arbitration algorithms according to processes to be executed by the plurality of bus masters.

3. The bus control system according to claim 1, wherein the arbitration algorithm control unit switches the plurality of arbitration algorithms before executing the processes of the plurality of bus masters.

4. The bus control system according to claim 1, wherein the arbitration algorithm control unit switches the plurality of the arbitration algorithms to an algorithm including a round robin method or a fixed priority method.

5. The bus control system according to claim 4, wherein the arbitration algorithm control unit switches the plurality of arbitration algorithms to a round robin method for a process that the plurality of bus masters almost equally use the bus; and
the arbitration algorithm control unit switches the plurality of arbitration algorithms to a fixed priority method for a process that the plurality of bus masters unequally use the bus.

6. The bus control system according to claim 4, wherein the arbitration algorithm control unit switches the plurality of arbitration algorithms to a round robin method for a process that the plurality of bus masters use the bus each with almost equal probabilities; and
the arbitration algorithm control unit switches the plurality of arbitration algorithms to a fixed priority method for a process that the plurality of bus masters use the bus each with different probabilities.

7. The bus control system according to claim 1, wherein the arbiter groups the plurality of the bus master into a plurality of groups;
the arbiter arbitrates for the bus according to an arbitration algorithm within groups, an arbitration algorithm for arbitrating between the plurality of bus masters within the plurality of groups, and according to an arbitration algorithm between groups, an arbitration algorithm for arbitrating between the plurality of groups; and
the arbitration algorithm control unit switches the arbitration algorithm within groups and the arbitration algorithm between groups.

8. The bus control system according to claim 7, wherein the arbitration algorithm control unit switches the arbitration algorithm within groups and the arbitration algorithm between groups to an algorithm including a round robin method or a fixed priority method.

9. The bus control system according to claim 8, wherein the arbitration algorithm control unit switches the arbitration algorithm within groups to a round robin method for a process that processes to be executed by the plurality of bus masters included in the group equally use the bus;
the arbitration algorithm control unit switches the arbitration algorithm within groups to a fixed priority method for a process that processes to be executed by the plurality of bus masters included in the group unequally use the bus;
the arbitration algorithm control unit switches the arbitration algorithm between groups to a round robin method for a process that processes to be executed by the plurality of bus masters included in the plurality of groups equally use the bus; and
the arbitration algorithm control unit switches the arbitration algorithm between groups to a fixed priority method for a process that processes to be executed by the plurality of bus masters included in the plurality of groups unequally use the bus.

10. The bus control system according to claim 8, wherein the arbitration algorithm control unit switches the arbitration algorithm within groups to a round robin method for a process that processes to be executed by the plurality of bus masters included in the group use the bus each with almost equal probabilities;
the arbitration algorithm control unit switches the arbitration algorithm within groups to a fixed priority method for a process that processes to be executed by the plurality of bus masters included in the group use the bus each with different probabilities;
the arbitration algorithm control unit switches the arbitration algorithm between groups to a round robin method for a process that processes to be executed by the plurality of bus masters included in the plurality of groups use the bus each with almost equal probabilities; and
the arbitration algorithm control unit switches the arbitration algorithm between groups to a fixed priority method for a process that processes to be executed by the plurality of bus masters included in the plurality of groups use the bus each with different probabilities.

11. The bus control system according to claim 1, further comprising an algorithm register for setting the arbitration algorithm,
wherein the arbitration algorithm control unit sets the arbitration algorithm to switch to the algorithm register; and
the bus arbiter arbitrates between the plurality of bus masters according to the arbitration algorithm set to the algorithm register.

12. The bus control system according to claim 1, wherein the arbitration algorithm control unit is one of the plurality of bus masters.

13. A bus control system comprising:
a plurality of bus masters commonly connected to a bus;
a bus arbiter for arbitrating use of the bus between the plurality of bus masters according to a predetermined arbitration algorithms, and
an arbitration algorithm control unit for switching priorities or an arbitration order of the plurality of bus masters in the arbitration algorithm according to processes to be executed by the plurality of bus masters.

14. The bus control system according to claim 13, wherein the arbitration algorithm control unit switches the priorities or the arbitration order before executing the processes to be executed by the plurality of bus masters.

15. A bus control method for arbitrating use of a bus between a plurality of bus masters comprising:
arbitrating use of the bus between the plurality of bus masters according to any one of a plurality of predetermined arbitration algorithms; and
switching the plurality of arbitration algorithms.

16. The bus control method according to claim 15, wherein the switching of the plurality of arbitration algorithm is performed according to processes to be executed by the plurality of the bus masters.

17. The bus control method according to claim 15, wherein the switching of the arbitration algorithm is performed before executing the processes of the plurality of bus masters.

18. The bus control system according to claim 15, wherein the switching of the arbitration algorithm is to switch the plurality of the arbitration algorithms to an algorithm including a round robin method or a fixed priority method.
